(19) United States
(12) Patent Application Publication
(10) Pub. No.: US 2025/0284115 A1
(43) Pub. Date: Sep. 11, 2025

(54) Method for Treating an Optical Spacer

(71) Applicant: Technische Hochschule Wildau, Wildau (DE)

(72) Inventors: Claus Villringer, Berlin (DE); Sigurd Schrader, Berlin (DE); Jan Laufer, Berlin (DE)

(21) Appl. No.: 18/862,178

(22) PCT Filed: May 2, 2023
(86) PCT No.: PCT/EP2023/061493

§ 371 Date: Nov. 1, 2024

(30) Foreign Application Priority Data
May 3, 2022 (DE) 10 2022 110 797.3

(51) Int. Cl. G02B 26/00; H04N 23/10

(52) U.S. Cl. CPC G02B 26/001; H04N 23/10

(57) ABSTRACT

The invention relates to a method (100) for treating an optical spacer (203) for a Fabry-Perot resonator (205) comprising the steps of:
arranging the optical spacer in a Fabry-Perot resonator;
arranging the Fabry-Perot resonator in an optical system (200);
aligning a spatially modulated treatment beam (232) with the Fabry-Perot resonator, wherein the light is short-wave and thereby suitable to cause a change in the refractive index of the optical spacer;
aligning a test beam (212) with the Fabry-Perot resonator;
spatially resolved detecting of a reflected or transmitted portion of the test beam aligned with the Fabry-Perot resonator, wherein the reflected or transmitted portion indicates location-dependent resonance wavelengths of the Fabry-Perot resonator;
spatially resolved adjusting of a location-dependent irradiance of the spatially modulated treatment beam based on the detected reflected or transmitted portion.

### CROSS REFERENCE TO RELATED APPLICATIONS

This application is the U.S. national stage of International Application No. PCT/EP2023/061491, filed on 2023 May 2. The international application claims the priority of DE 102022110797.3 filed on 2022 May 3; all applications are incorporated by reference herein in their entirety.

### BACKGROUND

The invention relates to a method for treating an optical spacer for a Fabry-Perot resonator. Furthermore, the invention relates to a homogenized optical spacer treated by the method. The invention also relates to a use of the homogenized optical spacer in a Fabry-Perot resonator and/or in a spectral camera, in particular in a hyperspectral camera. Ultimately, the invention also relates to a computer program for carrying out process steps of the method.

It is known to use optical spacers in Fabry-Perot resonators in order to obtain a beam with a resonance wavelength of the Fabry-Perot resonator. For this purpose, the Fabry-Perot resonator typically has two dichroic mirrors, between which the optical spacer is located. Due to their structure, Fabry-Perot resonators have regular resonance wavelengths in the transmission spectrum, between which lies the so-called free spectral range, the spectral portions of which are filtered out by the Fabry-Perot resonator. In order to continue working with only one resonance wavelength of the Fabry-Perot resonator, it is known to use a bandpass filter, in particular an adjustable bandpass filter, through which only light in the range of one of the resonance wavelengths of the Fabry-Perot resonator passes.

Furthermore, it is known that the resonance wavelength of the Fabry-Perot resonator can be changed by a change in temperature of the optical spacer and a resulting change in the optical thickness of the spacer. However, since the position of the resonance wavelength in the transmission spectrum and its bandwidth strongly depend on the location-dependent optical thickness of the spacer, a particularly homogeneous optical thickness of the optical spacer is necessary for practical applications of such an adjustable Fabry-Perot resonator, in particular to enable a low bandwidth.

Based on this finding, a method was presented, for example, in “Development of tuneable Fabry-Perot sensors for parallelised photoacoustic signal acquisition” (Villringer et al.; Proc. Of SPIE Vol. 10878; doi: 10.1117/12.2509437), in which a photopolymer is used as an optical spacer. Photopolymers, such as in this case the photopolymer poly(vinyl cinnamate) (PVCi), can have the property that they permanently change their refractive index when irradiated with short-wave light, i.e. in particular with light in the UV range, and thus their optical thickness can be changed by irradiation with such light. In said document, it is described that the optical thickness of a corresponding optical spacer is measured in a spatially resolved manner in order to subsequently change the thickness with short-wave light and thereby homogenize it.

### SUMMARY

The invention relates to a method (100) for treating an optical spacer (203) for a Fabry-Perot resonator (205) comprising the steps of:
arranging the optical spacer in a Fabry-Perot resonator;
arranging the Fabry-Perot resonator in an optical system (200);
aligning a spatially modulated treatment beam (232) with the Fabry-Perot resonator, wherein the light is short-wave and thereby suitable to cause a change in the refractive index of the optical spacer;
aligning a test beam (212) with the Fabry-Perot resonator;
spatially resolved detecting of a reflected or transmitted portion of the test beam aligned with the Fabry-Perot resonator, wherein the reflected or transmitted portion indicates location-dependent resonance wavelengths of the Fabry-Perot resonator;
spatially resolved adjusting of a location-dependent irradiance of the spatially modulated treatment beam based on the detected reflected or transmitted portion.

### DETAILED DESCRIPTION

Object of the present invention is to enable improved processing, in particular rapid processing, preferably rapid homogenization, of the optical spacer.

According to a first aspect of the invention, a method for treating an optical spacer for a Fabry-Perot resonator is proposed for attaining this object. The method comprises the steps of:
arranging the optical spacer, which, at least partially, consists of a photopolymer, in a Fabry-Perot resonator, so that the Fabry-Perot resonator comprises two dichroic mirrors separated from one another by the optical spacer;
arranging the Fabry-Perot resonator in an optical system;
aligning a spatially modulated treatment beam with the Fabry-Perot resonator, wherein the spatially modulated treatment beam comprises light from a short-wave range, wherein the light from the short-wave range is suitable to cause a change in the refractive index of the optical spacer;
aligning a test beam, in particular an optically expanded test beam, with the Fabry-Perot resonator;
spatially resolved detecting of a reflected or transmitted portion of the test beam aligned with the Fabry-Perot resonator, wherein the reflected or transmitted portion indicates location-dependent resonance wavelengths of the Fabry-Perot resonator; and
spatially resolved adjusting of a location-dependent irradiance of the spatially modulated treatment beam based on the detected reflected or transmitted portion, such that the caused change in the refractive index reduces a variance of indicated location-dependent resonance wavelengths of the Fabry-Perot resonator.

A spacer produced in this way can be advantageously used in a camera, in particular in a hyperspectral camera and/or in a sensor, in particular in a Fabry-Perot resonator, which is at least part of a sensor, for carrying out measurements or generating suitable measured values, resp.

In the context of the invention, it was recognized that during the spatial change of the refractive index of the spacer by the treatment beam, the resulting outcome should be tested promptly in order to be able to achieve homogenization of the optical thickness of the optical spacer as quickly as possible. For this purpose, according to the invention, the use of two beams, namely the treatment beam and the test beam, is proposed. In that, the irradiance of the treatment beam can always be adapted to the currently detected reflected or transmitted portion of the test beam.

In the context of the method according to the invention, a time-consuming method with an alternating sequence of test steps and processing steps is advantageously shortened by the simultaneous execution of test steps and processing steps.

In that, the method of the invention permits automated execution of the latter two process steps, i.e. the spatially resolved detection of the reflected or transmitted portion and the spatially resolved adjustment of the location-dependent irradiance. By automating parts of the method in this way, the treatment of the optical spacer can be carried out particularly quickly, depending on the automation technology used.

The method of the invention allows a cost-effective treatment of the optical spacer, since all the necessary components of the arrangement for carrying out the method can already be purchased commercially and therefore do not have to be specially manufactured. Only programming for any process steps to be automated would have to be provided in accordance with the invention.

With the spatially resolved adjustment of the location-dependent irradiance, the entire optical spacer can be treated with just one spatially modulated treatment beam. In particular, no time-consuming adjustment of the alignment of the treatment beam is necessary. In this respect, the spatially resolved adjustment of the location-dependent irradiance in particular describes a spatially resolved adjustment of the location-dependent irradiance with essentially constant alignment of the treatment beam.

Preferably, the process steps of arranging the components and aligning the beams are only performed once at the beginning of the process. The two steps of spatially resolved detection of a reflected or transmitted portion and spatially resolved adjustment of a location-dependent irradiance are preferably performed repeatedly. Repeated execution can further reduce the variance of the indicated location-dependent resonance wavelengths of the Fabry-Perot resonator with each resulting change in the refractive index. As a result, the optical thickness can be further homogenized along the surface of the optical spacer.

In accordance with the invention, a treatment of the optical spacer is to be understood as processing of the optical thickness of the optical spacer. According to the invention, this processing of the optical thickness leads to a reduction in the variance of location-dependent resonance wavelengths of the Fabry-Perot resonator. In this sense, according to the invention, a homogenization of the optical spacer takes place, namely a treatment to provide a homogeneous optical thickness over the relevant extent of the optical spacer. Therefore, an optical spacer treated in this way is also referred to below as a homogenized optical spacer.

In order to reduce the variance of the indicated location-dependent resonance wavelengths, according to the invention, it is not necessary to determine this variance. Alternatively, or in addition to the variance, other measures that correlate with the variance are also determined in embodiments according to the invention.

The location-dependent resonance wavelength does not have to be explicitly determined for the method of the invention. In some embodiments according to the invention, other location-dependent properties of the Fabry-Perot resonator are determined from the detected reflected or transmitted portion, which directly indicate the location-dependent resonance wavelength and/or are strongly correlated with it.

The method of the invention can be carried out both with the reflected portion and with the transmitted portion of the test beam aligned with the Fabry-Perot resonator, since the current resonance wavelength can at least theoretically be determined from both portions. In practice, however, it is simpler to determine the current spatially resolved resonance wavelength or a corresponding property of the Fabry-Perot resonator from the reflected portion of the test beam aligned with the Fabry-Perot resonator. An example of this is explained in the context of FIG. 2. Therefore, the use of the reflected portion is a preferred variant of the method according to the invention.

Preferred embodiments of the method according to the invention are described below.

In a particularly preferred embodiment of the method, a smallest indicated resonance wavelength of the Fabry-Perot resonator is determined for adjusting the location-dependent irradiance, and the location-dependent irradiance is selected such that a change in the refractive index caused by the spatially modulated treatment beam causes a reduction of the respective location-dependent resonance wavelength substantially towards the smallest indicated resonance wavelength. The change in the refractive index proposed in this embodiment based on an orientation to the smallest indicated resonance wavelength enables particularly simple control of the adaptation of the location-dependent irradiance of the spatially modulated treatment beam. Thus, only the smallest indicated resonance wavelength has to be taken as the basis for the location-dependent irradiance to be used in the next step. The method according to this embodiment is also advantageous in view of the fact that the irradiation of the photopolymer usually causes a reduction in the resonance wavelength at the irradiated location.

Preferably, the treatment beam used in the method according to the invention comprises light with a wavelength of less than 450 nm, in particular less than 420 nm. Particularly preferred, the treatment beam is light from the ultraviolet spectral range. Such short-wave light is particularly suitable for carrying out the change in the refractive index according to the invention.

The photopolymer used for the optical spacer is, for example, a photopolymer, which has cinnamoyl groups in its chemical composition, in particular, for example, it is the photopolymer poly(vinyl cinnamate) (PVCi). Other photopolymers with the properties relevant to the invention are also known to the skilled person and can be used accordingly for the method of the invention.

In a further embodiment, the method of the invention further comprises adjusting a duration of irradiation with the spatially modulated treatment beam based on the detected reflected or transmitted portion. In this embodiment, in addition to the irradiance, the duration of irradiation with the spatially modulated treatment beam is also adjusted. In this way, an adjustment of the irradiance can be partially avoided, since the desired change in the refractive index can likewise be achieved by longer irradiation, for example.

In a particularly preferred embodiment of the method according to the invention, the Fabry-Perot resonator is irradiated simultaneously by the test beam and the treatment beam. Simultaneous irradiation enables the method to be carried out in a particularly time-efficient manner. Thus, for example, the spatially resolved adjustment of the irradiance can be carried out while the reflected or transmitted portion is still being detected. In that, simultaneous irradiation can be made possible via various optical arrangements. In a preferred variant of the previous embodiment, simultaneous irradiation by the treatment beam and the test beam is made possible by inserting a dichroic mirror into the optical system. The dichroic mirror makes it particularly easy to superimpose beams from different radiation sources to form a combined beam and thus irradiate them simultaneously onto the Fabry-Perot resonator. Details of possible optical arrangements are shown and explained in the context of the description of the figures.

In a particularly advantageous embodiment, the spatially resolved detection of the reflected or transmitted portion and the spatially resolved adjustment of the location-dependent irradiance are automated. In this embodiment, the method can be executed particularly quickly, since no manual intermediate steps, for example for adjusting the irradiance, are necessary. In an advantageous variant of this embodiment, the Fabry-Perot resonator is irradiated simultaneously by the test beam and the treatment beam. In this variant, several advantageous variants of process steps are combined, each of which can contribute to an advantageous acceleration of the method according to the invention. Thus, both the partial automation of process steps and the possible simultaneous execution of process steps can shorten a duration of the method according to the invention.

In a particularly advantageous embodiment of the method according to the invention, the spatially resolved detection of the reflected or transmitted portion and the spatially resolved adjustment of the location-dependent irradiance based thereon are repeated until a predetermined threshold value for the variance of indicated location-dependent resonance wavelengths of the Fabry-Perot resonator is reached at least in a relevant treatment area of the optical spacer. The proposed repetition of the process steps until the threshold value is reached advantageously enables automation of these process steps. In that, the relevant treatment area of the optical spacer is a spatial area of the optical spacer in the vicinity of the optical axis planned in later applications. In that, this spatial area may depend on the subsequent application, since there may be applications, in which beams are to be filtered that hit the optical spacer at a considerable distance from the optical axis. The predetermined threshold value according to the proposed variant can be a threshold value of the variance. Alternatively, or additionally, the predetermined threshold value can be another variable, in particular another statistical variable for the evaluation of a distribution of measured values. In that, the predetermined threshold value preferably correlates with the variance of indicated location-dependent resonance wavelengths and in this sense implicitly forms a predetermined threshold value for this variance.

According to a second aspect of the invention, a homogenized optical spacer is proposed for attaining the object stated above. In that, the homogenized optical spacer according to the invention was treated according to an embodiment of the method in accordance with the first aspect of the invention.

A homogenized optical spacer produced in this way can have comparatively large dimensions, since the treatment for homogenization can be carried out particularly quickly according to the first aspect of the invention. Only through this rapid homogenization can optical spacers with large dimensions be made usable in practice.

Thus, the homogenized optical spacer preferably has a cross-sectional area perpendicular to the intended optical axis of at least 100 mm², in particular of at least 200 mm². Such a large cross-sectional area allows many commercial applications for such an optical spacer. For example, this homogenized optical spacer with this size can be advantageously used in a spectral camera and/or for camera-based photoacoustic imaging. Particularly suitable uses also relate to the use of the homogenized optical spacer in a hyperspectral camera and/or in a sensor.

In a further preferred embodiment, the optical spacer according to the second aspect of the invention has a thickness between 1 μm and 50 μm. Such a thickness allows various commercial applications, in particular in a Fabry-Perot resonator.

According to a further aspect of the invention, a heating electrode for changing the resonance properties of a Fabry-Perot resonator is proposed for attaining the object stated above. In this case, the heating electrode enables, via a location-dependent layer thickness of the heating electrode and/or via a plurality of electrode strips of the heating electrode with, at least partially, different applied current intensities, an essentially spatially homogeneous heating of an optical spacer directly or indirectly arranged thereon, in particular of the optical spacer according to at least one embodiment in accordance with the second aspect of the invention.

In the context of this application, a heating electrode is to be understood as a device for heating by at least one electrode. In this respect, the heating electrode can also comprise several electrodes, which form parts of the heating electrode.

The heating electrode according to the further aspect of the invention can advantageously be used to enable particularly precise and homogeneous heating of the optical spacer. In combination with the particularly precise homogeneity of the layer thickness of the optical spacer according to the second aspect of the invention, this can enable particularly precise adjustability of the optical properties of the Fabry-Perot resonator via the heating electrode.

The use of the plurality of electrode strips is based on the finding that, due to convection, edge areas of the resonator structure must be heated more than a central area of the resonator structure by a heating electrode that is in two-dimensional contact. Several electrode strips can therefore be used to provide a heating profile, which allows the resonator structure to be heated essentially homogeneously.

Preferably, the electrode strips can be controlled separately; in particular, a current intensity applied to a respective electrode strip can be electrically controlled separately in order to ensure homogeneous heating. A possible structure of such a heating electrode results from the figure description in the context of FIGS. 6a and 6b.

It is particularly preferable to apply a higher current intensity to electrode strips in the edge area of the heating electrode than in a central area of the heating electrode. This can provide a heating profile that is advantageous for the homogeneous heating of the optical spacer.

In one embodiment, the electrode strips are at least partially interwoven.

According to a third aspect of the invention, a use of the homogenized optical spacer in a Fabry-Perot resonator is proposed to attain the object stated above.

According to the invention, the resonance properties of the Fabry-Perot resonator with the homogenized optical spacer can be adjusted location-independently via a heating electrode by homogeneous heating of the homogenized optical spacer.

The use according to the third aspect of the invention is particularly advantageous, since a particularly high degree of homogeneity of the optical thickness of the optical spacer can be achieved particularly quickly by the method for treating the optical spacer. Therefore, a resonance wavelength can be set precisely and location-independently for the Fabry-Perot resonator particularly well by the location-independent heating via the heating electrode.

In a preferred embodiment of the use according to the third aspect of the invention, the Fabry-Perot resonator is used in combination with an optical bandpass filter, wherein a bandwidth of the optical bandpass filter is smaller than a free spectral range of the Fabry-Perot resonator, in order to form, together with the Fabry-Perot resonator, an adjustable optical filter with a bandwidth of less than 150 pm, in particular of less than 100 pm. Such a low bandwidth is advantageously enabled by the method of the invention according to the first aspect of the invention. With such a low bandwidth, various commercial applications are advantageously possible.

According to a fourth aspect of the invention, a use of the homogenized optical spacer in a spectral camera, in particular in a hyperspectral camera, is proposed for attaining the object stated above. According to the invention, the spectral camera has a Fabry-Perot resonator, the resonance properties of which can be adjusted location-independently via a heating electrode by homogeneously heating the homogenized optical spacer. In this application, a combination of a Fabry-Perot resonator and an optical bandpass filter is preferably arranged as an adjustable optical filter in front of an imager. This enables imaging spectrography with a particularly high spectral resolution.

Against this background, the invention also relates to a spectral camera with a Fabry-Perot resonator, which, together with an optical bandpass filter, forms an adjustable optical filter, which is arranged in front of an imager unit of the spectral camera, wherein a bandwidth of the optical bandpass filter is smaller than a free spectral range of the Fabry-Perot resonator. Here, the resonance wavelength of the Fabry-Perot resonator, and thus of the optical filter, can be adjusted by changing a property of the optical spacer of the Fabry-Perot resonator. According to the invention, the optical spacer consists of a photopolymer. Preferably, a temperature of the optical spacer is increased by homogeneous heating, whereby the resonance wavelength shifts towards a larger resonance wavelength as the temperature increases. The homogeneous heating is preferably carried out by a heating electrode, which is in contact with the Fabry-Perot resonator and/or the optical spacer. Alternatively, or in addition to this example, a thickness of the optical spacer is changed by stretching or compression using piezoelectric actuators. For this purpose, a voltage is applied to one or more piezoelectric actuators in order to change the distance between the dichroic mirrors. With higher voltage, the resonance wavelength typically shifts towards larger wavelengths.

A similar combination of a Fabry-Perot resonator with an optical spacer and a heating electrode is also useful in the field of camera-based photoacoustic imaging. Such use is also included as an aspect of the present invention, in particular in the context of the third aspect of the present invention. In that, the heating electrode is used to shift the resonance wavelength in such a way that the point of the greatest change in reflection in the resonator transfer function is located at the wavelength of a laser irradiating the Fabry-Perot resonator. This makes a corresponding measurement setup particularly sensitive to deformations of the homogenized optical spacer caused by acoustic waves. Details of the implementation of such camera-based photoacoustic imaging are known to the skilled person and are therefore not described in detail below.

According to a fifth aspect of the invention, a computer program comprising a program code for performing process steps according to the first aspect of the invention is proposed. In that, the program code is executed on a computer, a processor or a programmable hardware component. In that, the process steps comprise at least the following steps of the method according to the first aspect of the invention:
spatially resolved detecting of a reflected or transmitted portion of a test beam aligned with a Fabry-Perot resonator, wherein the reflected or transmitted portion indicates location-dependent resonance wavelengths of the Fabry-Perot resonator;
spatially resolved adjusting of a location-dependent irradiance of a spatially modulated treatment beam based on the detected reflected or transmitted portion such that a caused change in the refractive index reduces a variance of indicated location-dependent resonance wavelengths of the Fabry-Perot resonator.

Preferably, several steps of the method according to the invention are executed by a common computer, a common processor or a common programmable hardware component. Preferably, the individual steps are separated from each other at least at the software level by corresponding software blocks. Particularly preferred, all steps of the method according to the invention are executed on a common computer, a common processor or a common programmable hardware component.

### BRIEF DESCRIPTION OF THE DRAWINGS

The invention will now be explained in more detail with reference to advantageous embodiments shown schematically in the figures. In detail, in these:

FIG. 1 shows a flowchart of an embodiment of a method according to a first aspect of the invention;

FIG. 2 shows a system for performing the method according to the first aspect of the invention;

FIG. 3 shows a schematic representation of an embodiment of a use of a homogenized optical spacer according to a third aspect of the invention in a Fabry-Perot resonator;

FIG. 4 shows a diagram with a transmission spectrum of a Fabry-Perot resonator with a homogenized optical spacer according to a second aspect of the invention;

FIG. 5 shows a schematic representation of an embodiment of a use of a homogenized optical spacer according to a fourth aspect of the invention in a spectral camera;

FIG. 6A shows a schematic representation of an embodiment of a heating electrode according to a further aspect of the invention in a lateral view; and

FIG. 6A shows a schematic representation of an embodiment of a heating electrode according to a further aspect of the invention in a top view (FIG. 6b).

### DETAILED DESCRIPTION OF THE PREFERRED EMBODIMENTS

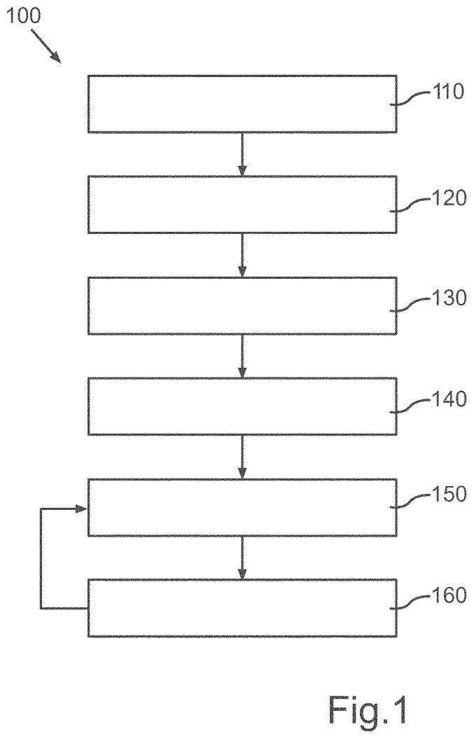

FIG. 1 shows a flowchart of an embodiment of a method 100 according a first aspect of the invention.

The method 100 is designed for treating an optical spacer for a Fabry-Perot resonator. In that, the method comprises the steps described below.

A first step 110 comprises arranging the optical spacer, which at least partially consists of a photopolymer, in a Fabry-Perot resonator such that the Fabry-Perot resonator comprises two dichroic mirrors separated by the optical spacer.

A next step 120 comprises an arrangement of the Fabry-Perot resonator in an optical system.

A subsequent step 130 comprises aligning a spatially modulated treatment beam with the Fabry-Perot resonator, wherein the spatially modulated treatment beam comprises light from a short-wave range, wherein the light from the short-wave range is suitable to cause a change in the refractive index of the optical spacer.

A further step 140 comprises aligning a test beam, in particular an optically expanded test beam, with the Fabry-Perot resonator.

A next step 150 comprises spatially resolved detecting of a reflected or transmitted portion of the test beam aligned with the Fabry-Perot resonator, wherein the reflected or transmitted portion indicates location-dependent resonance wavelengths of the Fabry-Perot resonator.

A final step 160 comprises spatially resolved adjusting of a location-dependent irradiance of the spatially modulated treatment beam based on the detected reflected or transmitted portion such that a variance of indicated location-dependent resonance wavelengths of the Fabry-Perot resonator is reduced by the caused change in the refractive index.

Steps 130 and 140 may be performed in any order. All further steps of the method 100 are preferably carried out in the order specified.

Preferably, the detecting according to step 150 is carried out repeatedly, in particular at regular time intervals. Particularly preferred, after adjusting the irradiance according to step 160, the reflected or transmitted portion according to step 150 is detected again in order to re-adjust the location-dependent irradiance as a function thereof.

Particularly preferred, switching between steps 150 and 160 is repeated until a predetermined threshold value for the variance of indicated location-dependent resonance wavelengths of the Fabry-Perot resonator is reached at least in a relevant treatment area of the optical spacer. This means that the method 100 is preferably only terminated when the location-dependent resonance wavelengths have a low variance at least in the relevant area of the optical spacer, i.e., for example close to the optical axis to be used. In this sense, the aim of the method 100 according to the invention is to homogenize the optical thickness of the optical spacer. Typical manufacturing variations of the optical thickness are so large that a more homogeneous optical thickness must be ensured for the applications of the optical spacer explained below, which is particularly advantageously enabled by the method 100.

Thus, in a variant of the illustrated embodiment, the two steps 150 and 160 are carried out automatically, for example based on a computer program with a program code for carrying out steps 150 and 160. Such an automated execution allows a particularly short duration of treatment of the optical spacer.

In that, the adjustment of the location-dependent irradiance can be carried out in various ways. A reference resonance wavelength is required for homogenization. This reference resonance wavelength can be a predetermined wavelength, or a resonance wavelength determined in the process can be used as the reference resonance wavelength. In a preferred variant, a smallest indicated resonance wavelength of the Fabry-Perot resonator is determined, and the location-dependent irradiance is selected such that a change in the refractive index caused by the spatially modulated treatment beam causes a reduction of the respective location-dependent resonance wavelength essentially towards the smallest indicated resonance wavelength. In this way, a sufficiently homogenized optical spacer can be provided particularly quickly, i.e. after a few iterations of steps 150 and 160.

In principle, according to the invention, in addition to the irradiance, a duration of irradiation with the spatially modulated treatment beam can also be adapted based on the detected reflected or transmitted portion. In this way, for example, particularly high irradiances can be avoided.

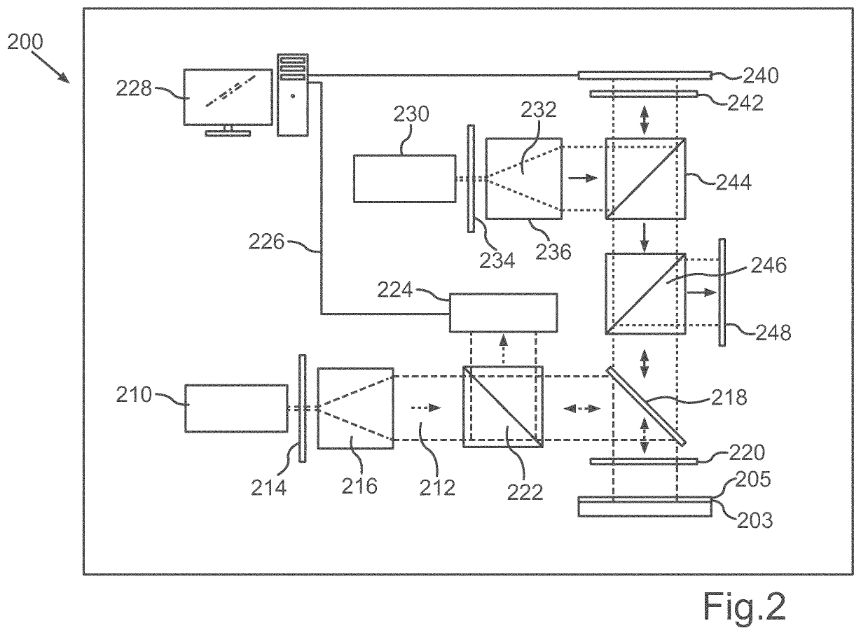

FIG. 2 shows a system 200 for performing the method according the first aspect of the invention.

The structure of this system 200 is exemplary. As is readily apparent to the skilled person in the field of optics, the method of the invention can also be implemented by structures, which differ significantly from the structure shown in FIG. 2.

The system 200 comprises a Fabry-Perot resonator 205 with the optical spacer 203, which partially reflects laser light from a test laser 210. The laser light forms the test beam 212 in the sense of the present invention and is shown as a dashed arrow within the optical system 200. After exiting the test laser 210, the test beam 212 passes a polarizer 214 and a beam expander 216. In front of the Fabry-Perot resonator 205, the test beam 212 is aligned by a dichroic mirror 218 in the direction of the optical axis of the Fabry-Perot resonator 205 and passes a quarter-wave plate 220. The portion of the then reflected light of the test beam 212 is guided to a camera 224 via the dichroic mirror 218 and a polarizing beam splitter 222, which camera sends a corresponding detection signal 226 to a computer 228. In that, the computer 228 forms a central control unit of the system 200.

The treatment beam 232 is provided by a treatment laser 230 and is shown as a solid arrow within the optical system. In that, after exiting the treatment laser 230, the treatment beam 232 again passes a polarizer 234 and a beam expander 236. The expanded treatment beam 232 is now modulated in its location-dependent irradiance via a light modulator 240 for spatial light modulation. For this purpose, the light modulator 240 is connected to the computer 228 via a signal. As a result, the computer 228 can take into account the reflected portion of the test beam 212 and thus, in particular, the distribution of the location-dependent resonance wavelengths of the Fabry-Perot resonator 205 when controlling the location-dependent irradiance. The treatment beam 232 preferably consists of light with a wavelength of less than 450 nm, in particular less than 420 nm. Such light, in particular ultraviolet light, is particularly suitable for changing the optical thickness of the optical spacer, which according to the invention is a photopolymer.

After spatial modulation by the light modulator 240, the modulated treatment beam 232 again passes a polarizer 242 and two polarizing beam splitters 244, 246 before passing the same dichroic mirror 218 as in the beam path of the test beam 212 in order to hit the Fabry-Perot resonator 205 with the optical spacer 203 after the quarter-wave plate 220.

The dichroic mirror 218 thus enables simultaneous irradiation of the optical spacer 203 by the test beam 212 and the treatment beam 232. Interferences between the two beams can be avoided by the polarizations correspondingly provided. The portion of the treatment beam 232 reflected by the Fabry-Perot resonator is removed from the optical system via the system of polarizing beam splitters and an absorber 248, so that the optical spacer 203 is actually treated only by the currently modulated treatment beam 232. In this way, the accuracy of the homogeneity of the optical spacer to be achieved can be increased, i.e. the variance of location-dependent resonance wavelengths of the Fabry-Perot resonator can be reduced.

The two lasers 210, 230 do not have to be changed in their alignment or in the laser light provided during the execution of the method according to the invention. The change in the treatment of the optical spacer 203 according to the invention only takes place via the light modulator 240.

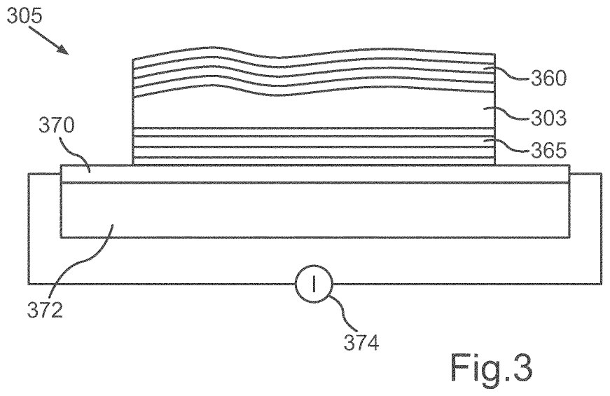

FIG. 3 shows a schematic representation of an embodiment of a use of a homogenized optical spacer 303 according to a third aspect of the invention in a Fabry-Perot resonator 305.

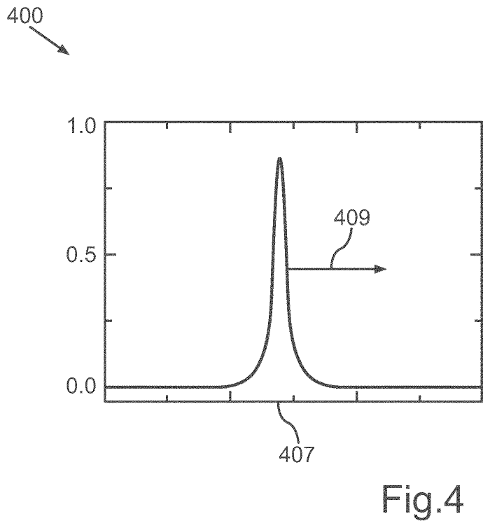

In that, the optical spacer 303 is in direct contact with the two dichroic mirrors 360, 365 of the Fabry-Perot resonator 305. The optical spacer has been treated according to the method in accordance with the first aspect of the invention and therefore has a homogenized optical thickness. As shown in FIG. 3, the actual geometrical thickness may not be exactly homogeneous, which, however, is irrelevant for the optical thickness. In order to change the resonance wavelength, in this use of the optical spacer, a heating electrode 370 is arranged at the Fabry-Perot resonator, via which the optical spacer 303 can be heated homogeneously. The resulting change in the transmission spectrum of the Fabry-Perot resonator 305 is described in FIG. 4.

In order to operate the heating electrode 370, it is arranged on a support material 372 and connected to an adjustable current source 374.

The method of the invention advantageously enables particularly large dimensions of the homogenized optical spacer 303. Thus, the method ensures particularly rapid homogenization, so that homogenization of the spacer 303 and thus a narrow bandwidth of the Fabry-Perot resonator can also be realized in commercially reasonable periods of time, for example in less than 20 hours, in particular in less than 5 hours. For this purpose, the optical spacer can, for example, comprise a cross-sectional area perpendicular to the intended optical axis of at least 100 mm², in particular of at least 200 mm². Furthermore, the optical spacer 303 can have a thickness between 1 μm and 50 μm. In that, the bandwidth of the Fabry-Perot resonator is preferably in the range of 100 pm for a single resonance wavelength.

FIG. 4 shows a diagram with a transmission spectrum 400 of a Fabry-Perot resonator with a homogenized optical spacer according to a second aspect of the invention.

The diagram shows the wavelength in nm on the x-axis and the transmission scaled from 0 to 1 on the y-axis, wherein 1 means unfiltered transmission and 0 means complete filtering out of the corresponding spectral portion.

It can be seen in the transmission spectrum 400, that in the spectral range shown, only light with a very narrow bandwidth around the resonance wavelength 407 can pass through the Fabry-Perot resonator with the treated optical spacer. Preferably, the bandwidth is less than 150 pm, in particular less than 100 pm. This enables a particularly high spectral resolution for many possible applications, such as in imaging spectroscopy and/or in camera-based photoacoustic imaging.

Finally, FIG. 4 also shows an arrow 409, which represents the shift of the displayed spectrum with increasing temperature of the optical spacer. This forms the basis for the fact that the spectral properties of the optical filter realized via the optical spacer can be adjusted in a particularly controlled and reproducible manner by means of a heating electrode and a corresponding homogeneous heating of the optical spacer.

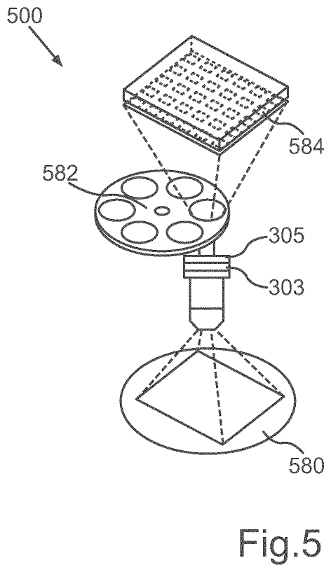

FIG. 5 shows a schematic representation of an embodiment of a use of a homogenized optical spacer 303 according to a fourth aspect of the invention in a spectral camera 500, in particular in a hyperspectral camera.

In this embodiment, wavelengths are captured in a hyperspectral data set 580, wherein the beams are spectrally filtered by a filter wheel 582 combined with the Fabry-Perot resonator 305 according to the third aspect of the invention. The filter wheel 582 forms an adjustable optical bandpass filter and is selected such that the respective bandwidth of a filter wheel setting of the filter wheel 582 is smaller than the free spectral range of the Fabry-Perot resonator 305. In this way, the combination of Fabry-Perot resonator 305 and filter wheel 582 forms an optical filter with exactly one resonance wavelength. This resonance wavelength is achieved, as explained above, due to the treatment of the optical spacer 303 according to the method in accordance with the first aspect of the invention, with a particularly small bandwidth of less than 150 pm, preferably less than 100 pm.

The beams with such a small bandwidth then reach an imager 584 of the spectral camera 500. Therefore, by using the homogenized optical spacer 303 in this manner, a particularly high spectral resolution of the correspondingly provided spectral camera is possible.

In addition to the described application in imaging spectroscopy, the Fabry-Perot resonator in accordance with the third aspect of the invention can also be used in the context of camera-based photoacoustic imaging. As is known, a different measurement setup is used for this. Thus, for example, the Fabry-Perot resonator can be irradiated over a large area with a laser, and the resonance wavelength is shifted by means of a heating electrode in such a way that the point of the greatest reflection change in the resonator transfer function is located at the wavelength of the laser. As a result, deformations of the homogenized optical spacer caused by acoustic waves lead to particularly large changes in the laser light reflected by the Fabry-Perot resonator. This change can be measured by a camera, for example.

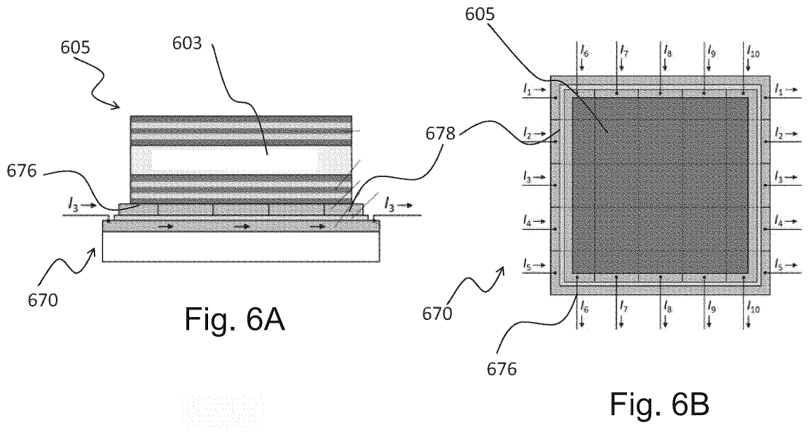

FIGS. 6a, b show a schematic representation of an embodiment of a heating electrode 670 according to a further aspect of the invention in a lateral view (FIG. 6a) and a top view (FIG. 6b). The heating electrode 670 shown has a plurality of, at least partially, differently energized electrode strips 676. In addition, the electrode strips 676 can each be controlled separately, which is also shown by the partially different currents I1 to I10 at the electrical contacts.

The Fabry-Perot resonator 605 shown in each case essentially corresponds to the Fabry-Perot resonators from the preceding embodiments. In particular, the Fabry-Perot resonator 605 is preferably equipped with an optical spacer 603 according to the second aspect of the invention, so that homogeneous heating of the spacer 603 also leads to a substantially homogeneous change of the optical properties, i.e. in particular of the resonance wavelength of the Fabry-Perot resonator 605.

Preferably, electrode strips 676, which have a comparable position relative to the optical spacer 603, are operated with substantially the same current. Thus, for example, the electrode strips 676 at the four corners of the square optical spacer 603 are substantially heated with the same current intensity.

In the embodiment shown, the electrode strips 676 can be controlled separately in order to ensure homogeneous heating. As a result, depending on a desired thickness of the optical spacer 603, for example, a current intensity respectively applied can be changed depending on the location of the respective electrode strip 676. For example, electrode strips 676 in the edge area of the heating electrode 670 can be heated up more than electrode strips 676 in the central area of the heating electrode 670. This allows account to be taken of the fact that the edge areas remain cooler than a central area of the heating electrode 670 due to convection. If all areas of the heating electrode had the same temperature independent of their location, this would result in inhomogeneous heating of the resonator structure.

In the present embodiment, an isolator 678 between electrodes of the heating electrode is formed by SiO2.

### LIST OF REFERENCE NUMERALS

100 Method
110, 120, 130, 140, 150, 160 Steps of the method
200 System
203, 303, 603 Optical spacer
205, 305, 605 Fabry-Perot resonator
210 Test laser
212 Test beam
214, 234, 242 Polarizer
216, 236 Beam expander
218, 360, 365 Dichroic mirror
220 Quarter-wave plate
222, 244, 246 Polarizing beam splitter
224 Camera
226 Detection signal
228 Computer
230 Treatment laser
232 Treatment beam
240 Beam modulator for spatial beam modulation
248 Absorber
370, 670 Heating electrode
372 Support material
374 Current source
400 Transmission spectrum
407 Resonance wavelength
409 Arrow
500 Spectral camera
580 Hyperspectral data set
582 Filter wheel forming an optical bandpass filter
584 Imager
676 Electrode strips
678 Isolator
I1 to I10 Current intensity

1. A method (100) for treating an optical spacer (203) for a Fabry-Perot resonator (205) comprising the steps of:
arranging the optical spacer (203), which, at least partially, consists of a photopolymer, in a Fabry-Perot resonator (205), so that the Fabry-Perot resonator (205) comprises two dichroic mirrors (360, 365) separated from one another by the optical spacer (203);
arranging the Fabry-Perot resonator (205) in an optical system (200);
aligning a spatially modulated treatment beam (232) with the Fabry-Perot resonator, wherein the spatially modulated treatment beam (232) comprises light from a short-wave range, wherein the light from the short-wave range is suitable to cause a change in the refractive index of the optical spacer (203);
aligning a test beam (212), in particular an optically expanded test beam, with the Fabry-Perot resonator (205);
spatially resolved detecting of a reflected or transmitted portion of the test beam (212) aligned with the Fabry-Perot resonator (205), wherein the reflected or transmitted portion indicates location-dependent resonance wavelengths of the Fabry-Perot (205) resonator; and
spatially resolved adjusting of a location-dependent irradiance of the spatially modulated treatment beam (232) based on the detected reflected or transmitted portion, such that the caused change in the refractive index reduces a variance of indicated location-dependent resonance wavelengths of the Fabry-Perot resonator (205).

2. The method (100) according to claim 1, wherein a smallest indicated resonance wavelength of the Fabry-Perot resonator (205) is determined for adjusting the location-dependent irradiance and the location-dependent irradiance is selected such that a change in the refractive index caused by the spatially modulated treatment beam (232) causes a reduction of the respective location-dependent resonance wavelength substantially towards the smallest indicated resonance wavelength.

3. The method (100) according to claim 1, wherein the treatment beam (232) comprises light with a wavelength of less than 450 nm, in particular less than 420 nm.

4. The method (100) according to claim 1, further comprising adjusting a duration of irradiation with the spatially modulated treatment beam (232) based on the detected reflected or transmitted portion.

5. The method (100) according to claim 1, wherein the Fabry-Perot resonator (205) is simultaneously irradiated by the test beam (212) and the treatment beam (232).

6. The method (100) according to claim 5, wherein the simultaneous irradiation by the treatment beam (232) and the test beam (212) is made possible by inserting a dichroic mirror (218) into the optical system (200).

7. The method (100) according to claim 1, wherein the spatially resolved detecting of the reflected or transmitted portion and the spatially resolved adjusting of the location-dependent irradiance take place automatically.

8. The method (100) according to claim 1, wherein the spatially resolved detecting of the reflected or transmitted portion and the spatially resolved adjusting of the location-dependent irradiance based thereon are repeated until a predetermined threshold value for the variance of indicated location-dependent resonance wavelengths of the Fabry-Perot resonator (205) is reached at least in a relevant treatment area of the optical spacer (203).

9. A homogenized optical spacer (203) treated by a method (100) according to claim 1.

10. The homogenized optical spacer (203) according to claim 9, wherein a cross-sectional area of the homogenized optical spacer (203) perpendicular to the intended optical axis comprises at least 100 mm², in particular at least 200 mm².

11. The homogenized optical spacer (203) according to claim 9, which has a thickness between 1 μm and 50 μm.

12. A heating electrode for changing the resonance properties of a Fabry-Perot resonator, wherein the heating electrode enables a substantially spatially homogeneous heating of an optical spacer arranged thereon, in particular of the optical spacer according to claim 9, via a location-dependent layer thickness of the heating electrode and/or via a plurality of electrode strips of the heating electrode, to which, at least partially, various current intensities are applied.

13. The heating electrode according to claim 12, wherein the electrode strips can be electrically controlled separately to ensure homogeneous heating.

14. Use of a homogenized optical spacer (303) according to claim 9 in a Fabry-Perot resonator (305), the resonance properties of which can be adjusted in a location-independent manner via a heating electrode (370), in particular via a heating electrode according to claim 12, by homogeneously heating the homogenized optical spacer (303).

15. The use of a homogenized optical spacer (303) according to claim 14, wherein the Fabry-Perot resonator (305) is used in combination with an optical bandpass filter (582), and wherein a bandwidth of the optical bandpass filter (582) is smaller than a free spectral range of the Fabry-Perot resonator (305) to form an adjustable optical filter having a bandwidth of less than 150 pm, in particular less than 100 pm, together with the Fabry-Perot resonator (305).

16. Use of a homogenized optical spacer (303) according to claim 9 in a spectral camera (500), wherein the spectral camera (500) comprises a Fabry-Perot resonator (305), the resonance properties of which can be adjusted in a location-independent manner via a heating electrode (370), in particular via a heating electrode according to claim 12, by homogeneously heating the homogenized optical spacer (303).

17. A computer program with a program code for performing process steps (150, 160) when the program code is executed on a computer, a processor or a programmable hardware component, wherein the process steps comprise at least the following steps of the method according to claim 1:
spatially resolved detecting of a reflected or transmitted portion of a test beam (212) aligned with a Fabry-Perot resonator (205), wherein the reflected or transmitted portion indicates location-dependent resonance wavelengths of the Fabry-Perot resonator (205);
spatially resolved adjusting of a location-dependent irradiance of a spatially modulated treatment beam (232) based on the detected reflected or transmitted portion, such that a variance of indicated location-dependent resonance wavelengths of the Fabry-Perot resonator (205) is reduced by a caused change in the refractive index.
